(19) United States
(12) Patent Application Publication
(10) Pub. No.: US 2010/0287093 A1
(43) Pub. Date: Nov. 11, 2010

(54) System and Method for Collections on Delinquent Financial Accounts

(76) Inventors: Haijian He, Jersey City, NJ (US); Jenny Guofeng Zhang, San Diego, CA (US)

Correspondence Address: GIBBONS P.C., ONE GATEWAY CENTER, NEWARK, NJ, 07102, US

(21) Appl. No.: 12/775,755

(22) Filed: May 7, 2010

Related U.S. Application Data
(60) Provisional application No. 61/176,445, filed on May 7, 2009.

(51) Int. Cl. G06Q 40/00

(52) U.S. Cl. 705/38

(57) ABSTRACT

A computer-implemented method for selecting a financial services collection program to be applied to a delinquent debtor account. First, an ability to pay index (API) is computed as a function of one or more predetermined ability to pay indicators for the debtor. Next, a willingness to pay index (WPI) is computed as a function of one or more predetermined willingness to pay indicators for the debtor. One of a plurality of predetermined collection programs to be offered to the debtor is then selected as a function of each of the API and the WPI. The WPI is computed by evaluating one or more of a past action taken by the debtor or a past status of the debtor account.

### CROSS-REFERENCE TO RELATED APPLICATION

The present application is related to, incorporates by reference and claims the priority benefit of U.S. Provisional Application 61/176,445, filed May 7, 2009 and entitled “A Willingness and Affordability Decision Engine to improve collection efficiency in retail financial services.”

### FIELD OF THE INVENTION

The present application is directed to a system and method for determining a collection treatment for delinquent accounts, and more particularly, to a system and method for selecting a collection treatment based on an estimate of affordability to the debtor and an estimate of the debtor's willingness to pay.

### BACKGROUND OF THE INVENTION

Financial services companies (“creditors”) often design collection strategies for delinquent accounts based on proprietary risk assessment models. A typical proprietary risk assessment model, for example, will generate a risk score that estimates a likelihood that the account will be cured, or a likelihood that the account will remain uncured and require a charge-off of the uncollected debt. Collections efforts against debtors may then be prioritized according to the risk probabilities reflected in the generated risk scores.

For example, a financial services company may divide delinquent accounts into high-, medium-, and low-risk groups according to their risk scores. Accounts that are in the low-risk group may initially be given very light collection treatment (such as sending the debtor a reminder letter), followed by a phone call if payment has not arrived within a fixed time after the letter is sent. Accounts in the medium-risk group may receive a more intensive collection treatment including repeated direct communication with the debtor to secure a payment or to start a pay-down program. Accounts in the high-risk group may be designated for settlement (typically for less than 100% payment), or be designated for legal action to affect collections.

One short-coming of a risk-only based collection analysis based on a proprietary risk assessment model is that it does not specifically suggest what level of pay-down program or settlement is appropriate based upon a debtor's ability to pay, and does not predict whether or not the debtor will stick to the agreed-upon payment program.

Although many data aggregator companies collect financial information about consumers (including information about income, assets, and major expenses such as mortgage and car loans), this information is often incomplete and inaccurate. For example, while credit bureaus may collect information about consumer income and loans (e.g., mortgage loans, car loans, and other type of loans), these bureaus typically do not collect accurate consumer investment and asset information. Although more accurate income and investment data may be collected from another data aggregator, related information collected by the data aggregator and the credit bureau may be inconsistent and therefore difficult to resolve.

As a result, it would be desirable to develop a method using these multiple and varied pieces of income information to form a more reasonable understanding of a debtor's ability to pay for the purpose of forming a debt collection strategy.

### SUMMARY OF THE INVENTION

The inventors of the present invention have advantageously become aware that debtors of modest financial means may in some cases be more likely to honor a debt payment agreement than other debtors having greater financial means In other words, a willingness of the debtor to repay a debt may not be fully correlated with that debtor's ability to repay the debt. To date, willingness has been difficult to define and measure. As a result, the present invention incorporates a method to estimate a debtor's willingness to repay a debt, and to use this additional information in conjunction with an improved estimate of the debtor's ability to pay to form an effective debt collection strategy.

The present invention is directed to a system and method for selecting a financial services collection program to be applied to a debtor account. The collection program, alternatively referred to as a collection strategy, defines a series of actions to be taken by the creditor in order to address a debtor's delinquency in making scheduled payments directed to the account (including for example, such activities as writing to the debtor, calling the debtor, and preparing a settlement offer to settle the account) The invention incorporates models for computing an ability to pay index (API) as a function of one or more predetermined ability to pay indicators for the debtor, and models for computing a willingness to pay index (WPI) as a function of one or more predetermined willingness to pay indicators for the debtor. The invention enables one of a plurality of predetermined collection programs to be selected as a function of the API and the WPI for offer to the debtor. By assessing both the debtor's ability to pay in the form of the API and the debtor's willingness to pay in the form of the WPI, and using this information to select an appropriate collection program, the rate of acceptance of offers by debtors and the performance of accepted programs can be improved.

Each of the API and the WPI are preferably modeled as a function of one predetermined variables, which may for example be transformed into binary variables and linearly combined with equal weights to form a committee model. Based on historical data for a collection of debtor accounts, a cut-off value is selected for each binary variable that enables the committee model to distinguish a high charge-off rate sub-population in the historical data from a low charge-off rate sub-population in the data, and to distinguish a high liquidation rate sub-population in the data from a low liquidation rare sub-population in the data (for example, through conventional classification and regression tree analysis). In this manner, the API and WPI can be used to predict a high and low ability to pay and a high or low willingness to pay, respectively, for a debtor that is delinquent with respect to a current account.

### BRIEF DESCRIPTION OF THE DRAWINGS

The invention will become more readily apparent from the Detailed Description of the Invention, which proceeds with reference to the drawings, in which:

FIG. 1 shows a flow diagram illustrating an exemplary method for developing an account collections program according to the present invention;

FIG. 2 shows a flow diagram illustrating an exemplary method for selecting binary variables and cut-off values for a model to calculate an Ability to Pay Index (API);

FIG. 3 illustrates characteristics of an exemplary collections strategy based the API and on a Willingness to Pay Index (WPI), in accordance with principles of the present invention;

FIG. 4 illustrates an exemplary collections plan according to the collections strategy of FIG. 3, based on differentiated mail treatments;

FIG. 5 illustrates an exemplary collections plan according to the collections strategy of FIG. 3, based on telephone contact;

FIG. 6 shows a schematic diagram depicting a server computer suitable for implementing the exemplary method of FIG. 1; and

FIG. 7 illustrates an exemplary computer screen design for presenting API, WPI and collections plan information to a creditor.

### DETAILED DESCRIPTION OF THE INVENTION

Reference will now be made in detail to exemplary embodiments of the invention, including the best modes contemplated by the inventors for carrying out the invention. Examples of these exemplary embodiments are illustrated in the accompanying drawings. While the invention is described in conjunction with these embodiments, it will be understood that it is not intended to limit the invention to the described embodiments. Rather, the invention is also intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In other instances, well-known aspects have not been described in detail in order not to unnecessarily obscure the present invention.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this invention belongs.

Method for Developing an Account Collections Strategy

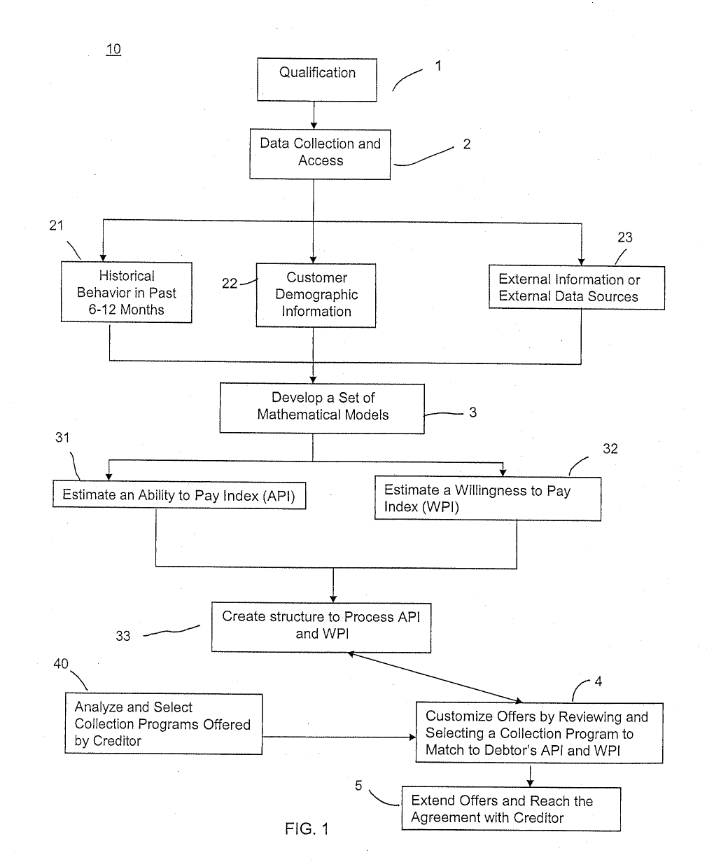

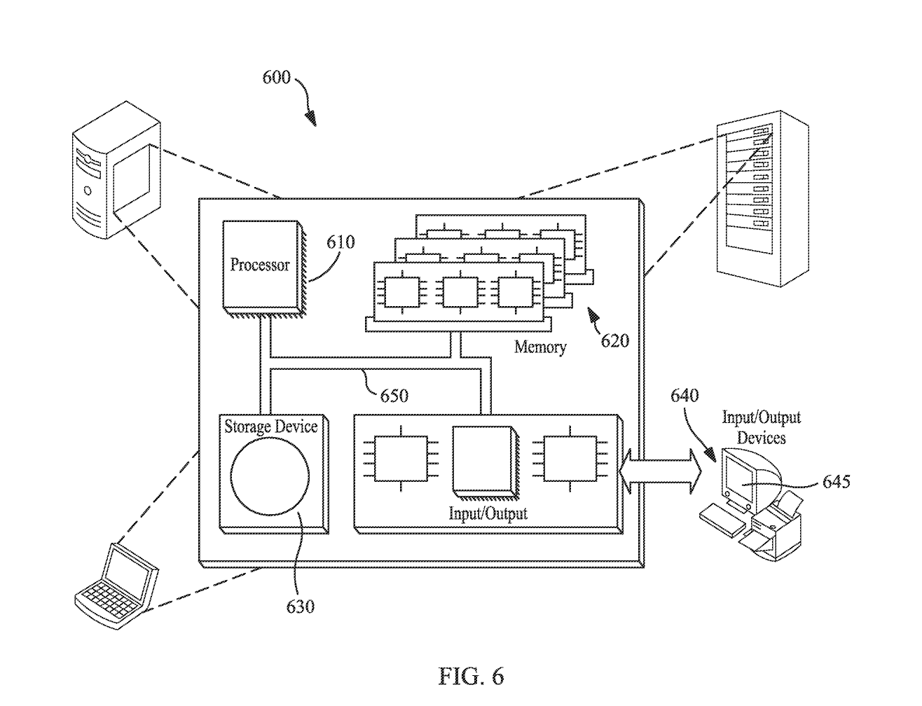

FIG. 1 shows a flow diagram 10 illustrating an exemplary method according to the present invention for developing an account collections strategy by estimating both a debtor's ability to pay and the debtor willingness to pay. The method 10 is particularly suitable for being implemented on the computer system 400 depicted in FIG. 6.

Referring to the method 10 in FIG. 1, at step 1, an analysis of the debtor's account is performed to determine whether the account is qualified to receive a collections treatment according to a predetermined rule. For example, the predetermined rule may provide that a collections treatment is triggered after a selected number of days past due (DPD) have accumulated after a payment due date on which no payment was received from the debtor.

Then in step 2, a data collection profile is established for collecting the data necessary for determining an Ability to Pay Index (API) and Willingness to Pay Index (WPI). The data collection profile may be selected, for example, based on debtor demographic information (step 22), the debtor's historical payment behavior (step 21), and/or data from other third party sources (step 23). An exemplary data collection profile is further described herein.

At step 3, mathematical models are used to produce the API for the debtor and an estimate of the debtor's free disposable cash for debt payment as recited in step 31, and for producing the WPI for the debtor as recited in step 32. Then, in step 33, the API and WPI are applied to select a payment program according to a payment behavior model. Exemplary models for the API, WPI and payment behavior are further described herein.

A representative set of available collection plans (“payment programs”) to be evaluated may be received, for example, a creditor (for example, a credit card issuer) as indicated in step 40. Actions taken by the creditor (or on behalf of the creditor by another collector) in accordance with exemplary payment programs may include, for example, an initial “friendly” reminder to the debtor to make payment without penalties or other sanctions, an attractive settlement that increases the debtor's incentives to pay, and/or the initiation of a legal process for collections.

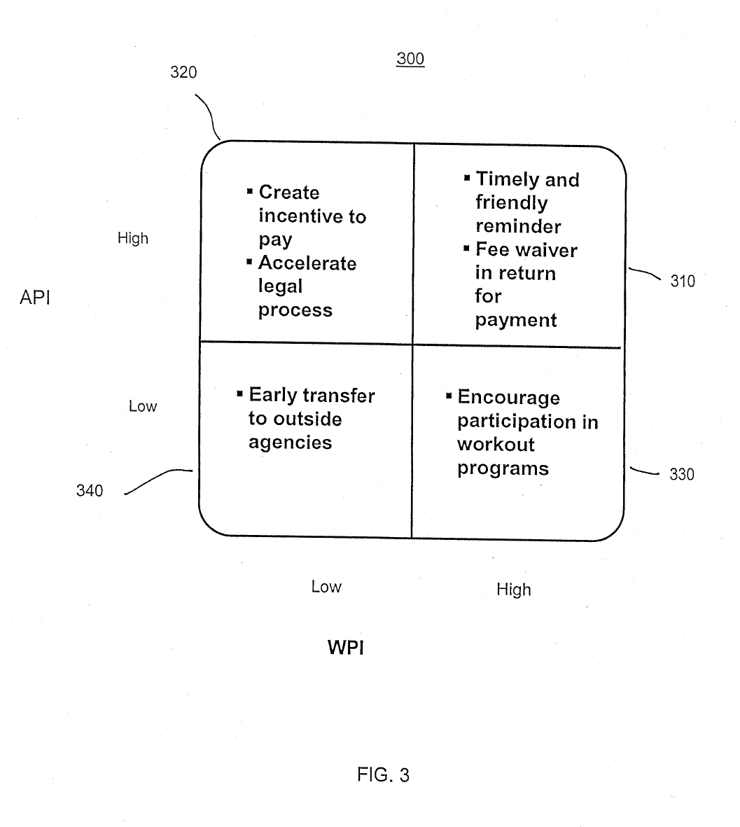

At step 4, the payment programs are evaluated in relation to API and WPI. Specifically, one of the available payment programs is selected as a preferred or best match in view of the API and WPI, and in view debtor's free disposable cash for debt payment. An exemplary selection process in accordance with the present invention is further described with reference to FIGS. 3-5. At step 5, the selected plan is presented to the debtor as a proposed collection offer.

API Computation

Table I illustrates an exemplary gap distribution for historical debt settlement offers which were not accepted by debtors, and thus which resulted in charge-offs by the creditors (“Charged-Off Accounts”). In this case, the gap percentage shown in Table I represents the difference between an estimated affordable settlement rate and a settlement rate that was actually offered to the debtor. The affordable settlement rate is determined, for example, as an estimate of the ratio of the debtor's annual estimated dispensable income to the total debt amount.

TABLE I
Charged-Off Account

| | % of Total Charged-Off | |
|---|---|---|
| Gap | Account | Average_Risk_Score |
| −40%− | 33% | 7,877.5 |
| −30% | 12% | 8,581.8 |
| −20% | 9% | 8,516.9 |
| −10% | 7% | 8,501.4 |
| −10%~+10% | 9% | 8,417.1 |
| +10% | 4% | 8,315.4 |
| +20% | 3% | 8,331.7 |
| +30%+ | 23% | 7,026.4 |
| Grand Total | 100% | 7,995.6 |

TABLE II
Settled Account

| Avg Gap | % of Total Settled Account |
|---|---|
| −47%− | 10% |
| −34% | 10% |
| −23% | 10% |
| −10% | 10% |
| −10%~+10% | 10% |
| +10% | 5% |
| +20% | 5% |
| +30%+ | 40% |
| Grand Total | 100% |

Table II complements Table I by illustrating an exemplary gap distribution for debt settlement offers which were accepted by debtors (“Settled Accounts”). Once again, the gap percentage is estimated as the ratio of the debtor's annual estimated dispensable income to the total debt amount.

With reference to Table I, it can be seen that the magnitude of the gap is correlated with a relative percentage of the accounts that are charged off (“% of Total Charged-Off Accounts”). In sharp contrast, the corresponding risk score calculated by using the proprietary risk assessment model of an associated creditor (“Average Risk Score) shows almost no correlation with the magnitude of the gap.

When comparing Tables I and II one can see that the charged-off accounts of Table I are dominated by accounts with negative gaps (for example, totaling at least 61% of all accounts), while the settled accounts of Table II have negative gaps for only about 40% of all accounts. As negative gaps represent an indication of a debtor's apparent inability to pay, the historical data suggests that collections efficiency may be increased by estimating API.

Because a debtor can potentially draw payment resources from many different sources (for example, including regular income, savings, income from investments, and the like), it is necessary to consider a number of different information sources in order effectively estimate API. In a preferred embodiment of the present invention, information is collected from credit bureaus, from other third party data aggregators, and from the creditor, and an API is produces, for example, in consideration of all creditor accounts that are 30 days past due (DPD), with the intention of offering appropriate payment programs and/or settlement programs for those past-due accounts that are predicted to be at high risk of being charged off.

Table III lists exemplary variables and data sources to be used in computing the API:

TABLE III

| Variable | Description | Source |
|---|---|---|
| V1_Income | Income | 3^{rd} party data |
| V2_All_asset | Value of assets per | 3^{rd} party data |
| | household | |
| V4_Fix_Incm_Asst | Fixed income assets per | 3^{rd} party data |
| | household | |
| V5_DC_Asst | Value of deposits and | 3^{rd} party data |
| | cash per household | |
| V6_CPT | Capacity to pay | Creditor data |
| V7_DSI | Disposable income score | Creditor data |
| V8_PVLV_OTB | Total open-to-buy on all | Credit bureau data |
| | revolving bankcards¹ | |
| V9_MP | Mortgage payment | Credit bureau data |
| V10_ALP | Auto loan payment | Credit bureau data |
| V11_TCCD | Total credit card debt | Credit bureau data |

¹In Table III, the variable “Total open-to-buy on all revolving bankcards” is computed as the total credit amount (limit) of all revolving bankcards less the total balance of all revolving bankcards.

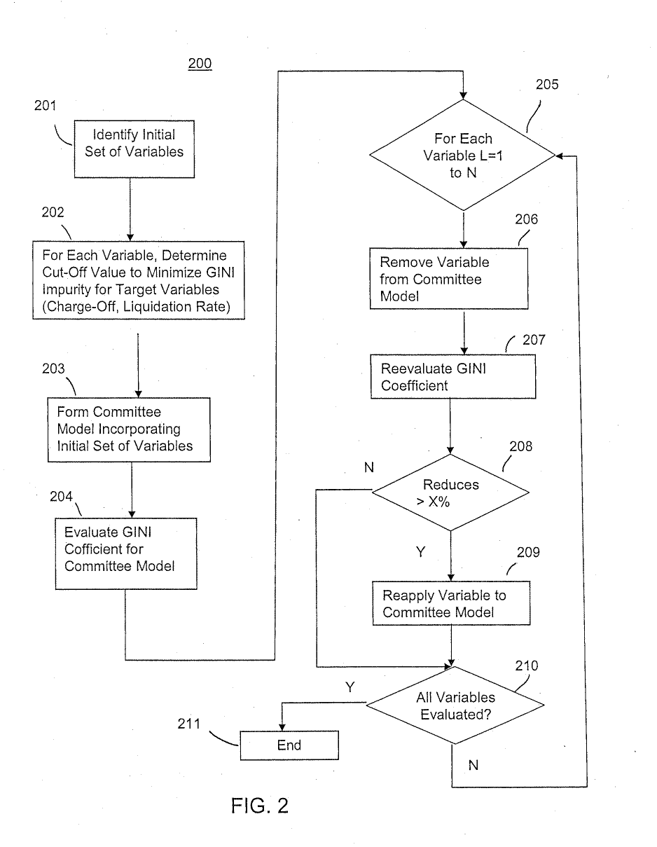

In accordance with an exemplary aspect of the present invention, each variable to be used in modeling the API is transformed into a binary variable. A “cut-off value” for making a binary value determination (i.e., “0” or “1”) is selected to maximize the separation between a high charge-off rate sub-population and a low charge-off rate sub-population, and also to separate high and low liquidation rate sub-populations. FIG. 2 shows a flow diagram 200 illustrating an exemplary method for selecting the binary variables and cut-off values.

Referring to flow diagram 200, at step 201, each of the variety of data sources is examined to determine an initial set of binary variables to be considered for the API model (for example, the exemplary variables listed in Table III). At step 202, a cut-off value is computed for each variable in the initial set according to its ability to separate or discriminate the high charge-off rate sub-population from the low charge-off rate sub-population and the high liquidation rate sub-population from the low liquidation rate sub-population. For example, in a preferred embodiment of the present invention, the cut-off value for each variable is independently computed to be a value that minimizes the “GINI impurity” value for each of the target variables (e.g., charge-off and liquidation rate). As used herein, the GINI impurity is a measure of how often a randomly chosen element from the population of data would be incorrectly labelled if it were randomly labelled according to the distribution of labels in the sub-population. The GINI impurity can be computed, for example, by summing the probability of each item being chosen times the probability of a mistake in categorizing that item. This step 202 operates in effect to build a one-variable, single-split Classification and Regression Tree (CART) model. Known methods for calculating the GINI impurity are described, for example, in Breiman et al., Classification and regression trees, Monterey, Calif.: Wadsworth & Brooks/Cole Advanced Books & Software, 1984, which is incorporated by reference herein in its entirety.

After the cut-off values are calculated in step 202, the binary variables are preferably combined to form a linear committee model in which all of the variables are represented with equal weights in step 203. This model is particularly appropriate when the data used for calculating the cut-off values has significant noise (i.e., is “unclean”). For “clean” data, an ensemble model with optimized weights can be used in place of the committee model. Ensemble models are described, for example, in Opitz et al., “Popular ensemble methods: An empirical study”. Journal of Artificial Intelligence Research 11: 169-198, 1999, which is incorporated by reference herein in its entirety.

Using the committee model formed at step 203, a “GINI coefficient” is computed for the model at step 204. The GINI coefficient is used to estimate the discriminatory power of the model, and is defined to have a value equal to twice the value of an area between a “line of equality” (i.e., a line representing the target value as being constant and independent of the values of the variables in the model) and a Lorenz curve (i.e., a curve for which the target value depends on the values of the variables in the model). Known methods for determining GINI coefficients in like models are described, for example, in more detail in Gastwirth, Joseph L. (1972). “The Estimation of the Lorenz Curve and Gini Index”. The Review of Economics and Statistics 54: 306-316, 1972, which is incorporated by reference herein in its entirety.

Then, beginning at step 205, the contribution of each binary variable to the discriminatory power of the model is evaluated. At step 206, a first one of the binary variables is removed from the model and the GINI coefficient is re-evaluated. At step 208, if the GINI coefficient decreases by more than X % (for example, 10%), the variable is determined to discriminate and is reapplied to the committee model at step 209. If the GINI coefficient decreases by less than X %, the variable is determined to be non-discriminatory and remains removed from the model. At step 510, the evaluation process continues to repeat steps 205-209 until each binary variable has been evaluated, at which point the process concludes at step 211.

Alternatively, other variable selection methods, such as Minimum Redundancy Maximum Relevance (mRMR), may be employed in accordance with the present invention. Suitable mRMR techniques are described, for exampler, in Peng et al., “Feature Selection Based on Mutual Information: Criteria of Max-Dependency, Max-Relevance and Min-Redundancy”. IEEE Transactions of Pattern Analysis and Machine Intelligence, 27, 8: 1226-1238, 2005, which is incorporated by reference herein in its entirety.

In the present example, it was found that three variables could be dropped without reducing the model's discrimination power:
V9_MP,
V10_ALP, and
V11_TCCD.

It should be noted that, in accordance with other examples using other data sets, these three variables may be required to be maintained while other variables may be suitably dropped

Thus, in the present example, and in accordance with exemplary method 200 described in conjunction with FIG. 2, an API was developed including the following variables and cut-values:

API=V1_Income+V2_All_Asset+V4_Fix_Incm_Asst+V5_{—}DC_Asst+V6_{—}CTP+V7_{—}DSI+V8_{—}PVLV_{—}OTB [1]

where:
if income<=$88,636 then V1_income=0; else V1_Income=1;
if value of asset per household<=$81,863 then V2_All_Asset=0; else V2_All_Asset=1;
if fixed income asset per household<=$34,930 then V4_Fix_Incm_Asst=0; else V4_Fix_Incm_Asst=1;
if value of deposit and cash per household<=$23,198 then V5_DC_Asst=0; else V5_DC_Asst=1;
if capacity to pay<=$16,974 then V6_CTP=0; else V6_CTP=1;
if disposable income score<=329 then V7_DSI=0; else V7_DSI=1;
if total open-to-buy on revolving bankcard<=$9,169 then V8_RVLV_OTB=0; else V8_RVLV_OTB=1;

Table IV illustrates several characteristics of the API calculated according to the above model based on historical data. Delinquent accounts classified having a “high” API (i.e., values of 4-7), which comprise 27% of the population (% Accum. Pop), received an average payment (“Avg Payment”) is 71% higher than average payments made for accounts having low API (i.e., values of 0-4). Average liquidation rates for the high API accounts are approximately 33% higher than average rates for low ability accounts, and average charge-off rates (“CO rate”) for high API accounts are approximately 88% lower than average CO rates for low API accounts. Finally, the average percentage of payments that were at least 90 days delinquent (“Hit 90DPD Rate”) is approximately 45% lower for high API accounts as compared to low API accounts.

TABLE IV

| | | % | | | Hit | |
|---|---|---|---|---|---|---|
| Ability to | % | Accum. | Avg | Liquidation | 90DPD | CO |
| Pay Index | Pop | Pop | Payment | Rate | Rate | Rate |
| 7 | 5% | 5% | $1,098 | 37% | 4% | 3% |
| 6 | 6% | 12% | $937 | 33% | 7% | 5% |
| 5 | 6% | 18% | $732 | 30% | 9% | 7% |
| 4 | 9% | 27% | $736 | 28% | 10% | 8% |
| 3 | 12% | 39% | $681 | 25% | 13% | 10% |
| 2 | 16% | 56% | $586 | 24% | 15% | 11% |
| 1 | 22% | 77% | $477 | 23% | 15% | 12% |
| 0 | 23% | 100% | $372 | 20% | 23% | 16% |

WPI Computation

In accordance with the present invention, a debtor's willingness to pay is assessed based past actions by the debtor that are indicative of level of effort to meet the current or similar obligations. Importantly, this assessment is made independently from assessing the debtor's monetary financial strength

Similarly to the API, the WPI may be constructed according to the method of FIG. 3 by forming a committee model that linearly combines a number of potential binary variables with equal weights, and then evaluating each potential binary variable using historical data to determine the discriminatory power of each potential binary variable with respect to one or more target variables (including, for example as in the case of API, charge-off and liquidation rate, and in addition, willingness to pay).

Because willingness to pay is not directly measurable as a target variable, a suitable proxy is required, preferably based on data that can be extracted from available creditor account data. For the present example, the proxy “Real Person Contact successful rate” (RPC) is used, and calculated based on available creditor data as the ratio of the number of successful debtor contacts made by the creditor to the number of total debtor telephone contacts attempted by the creditor

Table V lists the binary variables evaluated in the present example to prepare the WPI:

TABLE V

| Variable | Description |
|---|---|
| W1_Autm_Pay | Whether set up auto-pay within 6 |
| | months prior to DPD |
| W3_Pymt_Each_Mth | Made >=1 payment in each of |
| | the 6 months prior to DPD |
| W4_0purchase_200pymt | Whether within 6 months prior to |
| | DPD, there was no purchase, and |
| | monthly payment >= $200 |
| W6_Inc_Utlz_3Pymt | Within 6 months prior to DPD, |
| | utilization increased and payments |
| | were made in more than 3 months |
| W8_Paid_In_Full_Pre_6m | Within 6 months prior to DPD, has |
| | paid in full at least once |
| W9_Long_Current_Pre_6m | Within 6 months prior to DPD, has |
| | never been in delinquent status |
| W10_Inbound_Calls | Proactive inbound calls from the debtor |

In the present example, after evaluation according to the method 200 of FIG. 2, WPI includes the following binary (1/0) variables and cut-values:

$$WPI = w1\_autm \_pay + w3\_Pymt \_Each \_mth + w4\_ 0 purchase\_ 200 pymt + w6\_Inc \_Utlz \_ 3 Pymt + w8\_Paid \_In \_Full \_Pre \_ 6 m + w9\_Long \_Current \_Pre \_ 6 m \qquad [ 2 ]$$

It should be noted that, in the case of WPI, the associated cut-off values are effectively “embedded” in the definitions of the binary variables. For example, in the case of the variable W1_Autm_Pay (“Whether set up auto-pay within 6 months prior to DPD”), the cut-off analysis was performed in view of several possible time discriminators (e.g., whether auto-pay was set up 12, 9, 6, 4 or 2 months prior to DPD), and the value producing the highest discriminating power (6 months) was selected.

Table VI illustrates several characteristics of the WPI calculated according to the above model based on historical data. Delinquent accounts classified having a “low” WPI (e.g., values of 0 and 1), which comprise approximately 48% of the population (% Accum.Pop), have an average charge-off rate (“CO rate) that is 81% higher than the average rate for accounts with “high” WPI (e.g., values of 2-6). Accounts having a high WPI have on average a 20% higher Real Person Contact successful (“RPC”) rate than accounts having a low WPI. As illustrated by way of example for API in FIG. 6, accounts having high WPI exhibit higher average payment (“Avg Payment”) rates, higher liquidation rates, and lower average rates for the percentage of payments that were at least 90 days delinquent (“Hit 90DPD Rate”).

TABLE VI

| | | | % | | | Hit | | |
|---|---|---|---|---|---|---|---|---|
| | Willingness to | % | Accum. | Avg | Liquidation | 90DPD | CO | RPC |
| | Pay Index | Pop | Pop | Payment | Rate | Rate | Rate | Rate |
| High | 6 | 0.0% | 0% | $1,037 | 29.3% | 4.3% | 1.7% | 35% |
| | 5 | 0.3% | 0% | $859 | 28.4% | 3.2% | 2.7% | 16% |
| | 4 | 2.9% | 3% | $688 | 28.4% | 5.3% | 4.4% | 12% |
| | 3 | 14.6% | 18% | $667 | 33.4% | 7.5% | 5.7% | 11% |
| | 2 | 34.7% | 52% | $588 | 29.2% | 12.3% | 9.1% | 9% |
| Low | 1 | 31.3% | 84% | $582 | 21.5% | 17.6% | 13.1% | 8% |
| | 0 | 16.3% | 100% | $568 | 14.5% | 22.8% | 16.4% | 8% |

Payment Behavior Model

FIG. 3 depicts a payment behavior matrix 300 that illustrates core concepts for using the API and WPI in developing an exemplary payment behavior model. As shown in FIG. 8, the API and WPI can be classified into discrete groups, for example, into groups representative of low ability to pay and high ability to pay, and low willingness to pay and high willingness to pay, respectively. In the payment behavior matrix 300, distinct collection treatments are indicated for paired API/WPI groups. For example, for a paired API/WPI indicating a high ability to pay and high willingness to pay (cell 310), the payment behavior matrix 300 suggests a “friendly” reminder to the debtor without penalties or other sanctions. For a paired API/WPI indicating a high ability to pay and low willingness to pay (cell 320), the payment behavior matrix 300 suggests a collection action that increases the debtor's incentives to pay in combination with an accelerated legal process. For a paired API/WPI indicating a high willingness to pay and low ability to pay (cell 330), the payment behavior matrix 300 suggests a work out program or payment plan. For a paired API/WPI indicating both a low ability to pay and a low willingness to pay (cell 340), the payment behavior matrix 300 suggests a disposal of the collection action (for example, by sale or other transfer of the account to an outside agency.)

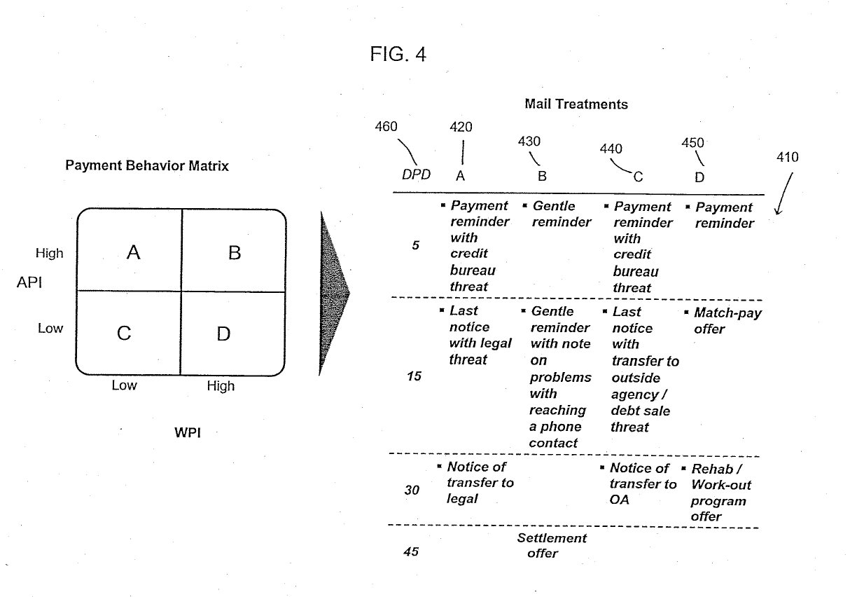

Consistent with the payment behavior matrix 300 of FIG. 3, FIG. 4 illustrates an example of a more detailed set of collection plans focused on mail treatments. In this case, plan actions are defined based both on debtor API/WPI groupings A-D, and on the basis of other qualifying conditions or events (in this case, accumulated number of days past due (DPD) from the deadline for the debtor's payment). In this case, the provision of successive mail treatments according to accumulated DPD reflects creditor experience suggesting that multiple contacts are often necessary for reaching a successful disposition.

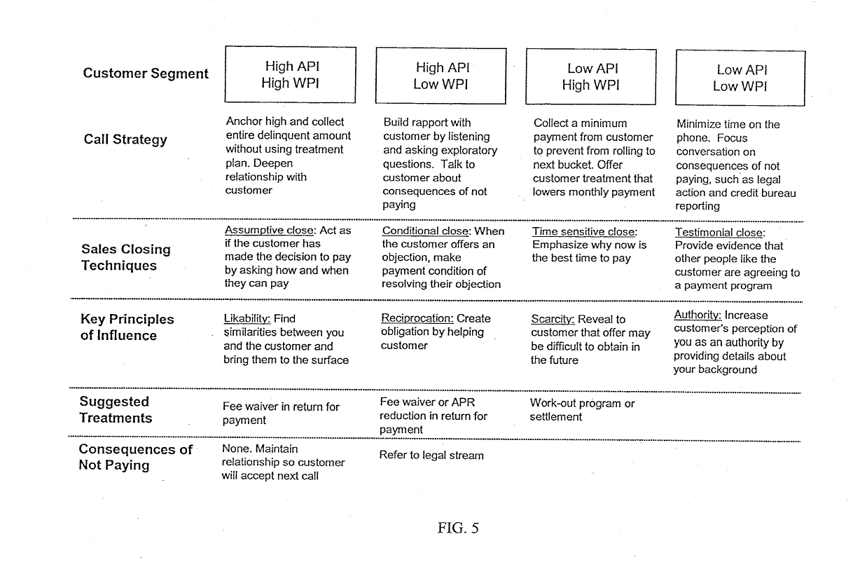

FIG. 5 shows yet another example of collection plans focused on telephone call treatments.

Implementation of Method for Developing the Accounts Collection Program

The disclosed method for developing the accounts collection program is particularly suitable for implementation using a computer or computer system as described in more detail below.

FIG. 6 shows an illustrative computer system 600 suitable for implementing the present invention. The computer system 600 as described herein may comprise, for example, a personal computer running the WINDOWS XP operation system, or a server computer running LINUX or another UNIX-based operating system. The above-described methods of the present invention may be implemented on the computer system 600 as stored program control instructions directed to control application software, for example, including statistical analysis software such as SAS.

Computer system 600 includes processor 610, memory 620, storage device 630 and input/output devices 640. One of the input/output devices 640 may include a display 645. Some or all of the components 610, 620, 630 and 640 may be interconnected by a system bus 650. Processor 610 may be single or multi-threaded and may have one or more cores. Processor 610 executes instructions which in the disclosed embodiments of the present invention are the steps described in one or more of FIGS. 1 and 2. These instructions are stored in memory 620 or in storage device 630. Information may be received and output using one or input/output devices 640.

Memory 620 may store information and may be a computer-readable medium, such as volatile or non-volatile memory. Storage device 630 may provide storage for system 600 including for the example, the previously described database, and may be a computer-readable medium. In various aspects, storage device 630 may be a flash memory device, a floppy disk drive, a hard disk device, and optical disk device, or a tape device.

Input devices 640 may provide input/output operations for system 600. Input/output devices 640 may include a keyboard, pointing device, and microphone. Input/output devices 640 may further include a display unit for displaying graphical user interfaces, a speaker and a printer. As shown the computer system 600 may be implemented in a desktop computer, or in a laptop computer, or in a server. The recommendations provided pursuant to the present invention can be provided on a computer display proximate to the computer system 600 or remote from such system and communicated wirelessly to a sales person's mobile communication device. In this manner, the recommendation can be personally presented to the target customer when such customer is visited by the seller's sales person. Alternatively, the recommendations for each target customer can be provided in mass to the seller for redistribution to the appropriate sales person that interacts with that target customer.

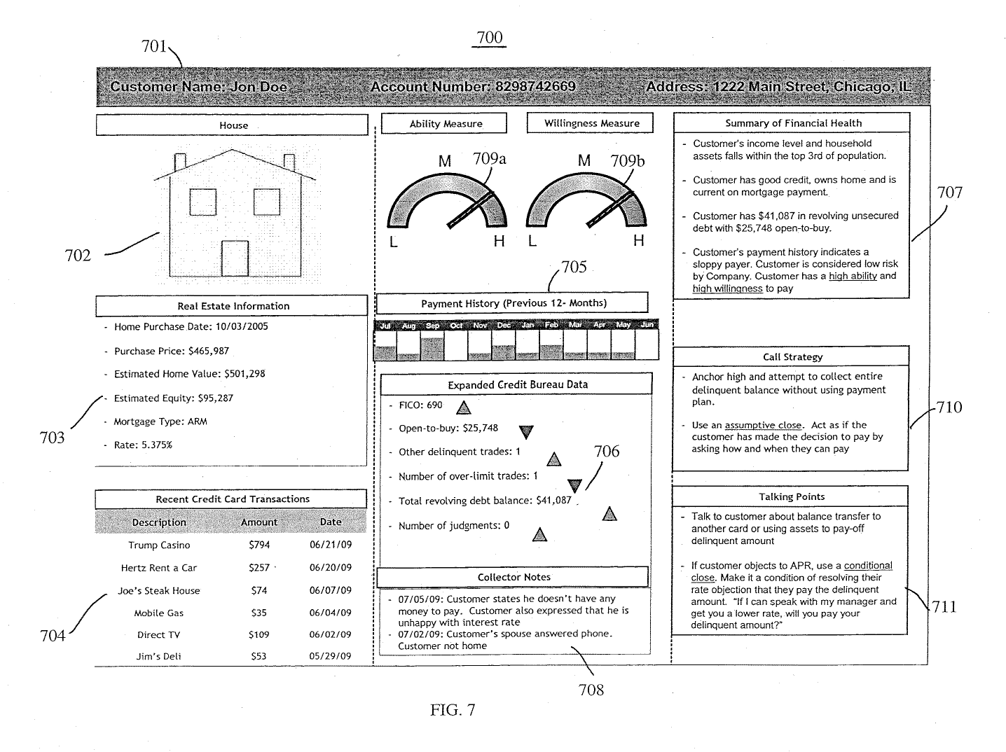

FIG. 7 illustrates an exemplary user interface screen 1100 for display on the display screen 645 that presents API, WPI and collections plan information in a convenient format for use by a creditor or by another collector.

As illustrated in FIG. 7, a screen 700 includes a header region 701 that for example includes information identifying the customer by name, by address and by the creditor's account number. Information about the debtor's assets and financial transactions is summarized on a leftmost panel of the screen 700. For example, the leftmost panel includes a photo 702 of the debtor's residence, below which real estate information panel 703 presents summary information relating to the debtor's real estate holdings. Further by way of example, a recent credit card transaction panel 704 is provided at a bottommost position of the leftmost panel of screen 700.

In a middle panel of the screen 700, for example, a payment history panel 705 is provided to indicate a history of the debtor's payment performance against the debt. Below the payment history panel 705, a summary of credit bureau data is provided in credit bureau data panel 706, including two graphical symbols (upward-pointing green triangles and downward-pointing red triangles) that illustrate positive and negative trends, respectively.

Below the credit bureau data panel 706, collector's notes are provided recording previous contacts with the debtor and associated results. At the top of the middle panel, API and WPI “gauges” 709a, 709b are provided to indicate the API and WPI, as computed for example according to the above-described API and WPI models, based on associated data for the debtor.

A rightmost panel of the screen 700 presents a further analysis of the information summarized in the leftmost and middle panels. At the top of the rightmost panel, for example, a financial health panel 707 is provided to summarize the debtor's financial health. As described above with reference to FIGS. 3-5, a payment plan is selected as a function of the values presented by the API and WPI “gauges” 709a, 709b, and presented to the creditor for example in a call strategy panel 710 and a talking points panel 711. It should be noted that, in the interests of security and privacy access to the screen 700 is strictly controlled (for example, by requiring a user login with password, digital certificate and/or other conventional secure access means). In addition, access may preferably be provided at several levels. For example, at a lower level of access, a more limited version of the screen 700 may be provided that omits sensitive components of the debtor's financial information (for example, the descriptions in panel 704 of the debtor's recent credit card purchases).

It should of course, be understood that while the present invention has been described with respect to disclosed embodiments, numerous variations are possible without departing from the spirit and scope of the present invention as defined in the claims. Moreover, it is intended that the scope of the present invention include all foreseeable equivalents to the elements and structures as described herein and with reference to FIGS. 2-10. Accordingly, the invention is to be limited only by the scope of the claims and their equivalents,

We claim:

1. A computer-implemented method for selecting a financial services collection program for a debtor account, the method comprising the steps of:
determining that the debtor account meets a qualifying condition;
computing an ability to pay index (API) as a function of a debt amount for the account and one or more predetermined ability to pay indicators for the debtor
computing a willingness to pay index (WPI) as a function of one or more predetermined willingness to pay indicators for the debtor; and
selecting one of a plurality of predetermined collection program offers for the customer as a function of the API and the WPI.

2. The method of claim 1, wherein the qualifying condition comprises a past-due condition for a payment on the account that persists for a predetermined number of days.

3. The method of claim 1, wherein the one or more predetermined ability to pay indicators are evaluated using information selected from the group consisting of income, household assets, financial accounts, and cash on hand.

4. The method of claim 1, wherein the one or more predetermined ability to pay indicators are evaluated using information selected from the group consisting of capacity to pay and disposable income score.

5. The method of claim 4, wherein the selected information is provided by a creditor for the account.

6. The method of claim 1, wherein the one or more ability to pay indicators are evaluated using information selected from the group consisting of credit limits on bankcards, credit balances on bankcards, loan balances and debtor discretionary spending.

7. The method of claim 6, wherein the selected information is provided by one or more credit bureaus.

8. The method of claim 1, wherein the one or more predetermined willingness to pay indicators are evaluated using information about one or more of a past action taken by the debtor or a past account status.

9. The method of claim 1, wherein the API is computed using a respective model implemented as a committee model, the committee model combining a plurality of binary variables each based on a respective one of the one or more predetermined ability to pay indicators and evaluated as a function of a respective predetermined cut-off value.

10. The method of claim 1, wherein the WPI is computed using a respective model implemented as a committee model, the committee model combining a plurality of binary variables each based on a respective one of the one or more predetermined willingness to pay indicators and evaluated as a function of a respective predetermined cut-off value.

11. A computer program product, comprising a computer-usable medium having computer-readable instructions embodied therein, the computer-readable program code adapted to be executed to implement a method for selecting a financial services collection program for a debtor account, the method comprising the steps of:
determining that the debtor account meets a qualifying condition;
computing an ability to pay index (API) as a function of a debt amount for the account and one or more predetermined ability to pay indicators for the debtor
computing a willingness to pay index (WPI) as a function of one or more predetermined willingness to pay indicators for the debtor; and
selecting one of a plurality of predetermined collection program offers for the customer as a function of the API and the WPI.

12. The computer program product of claim 11, wherein the qualifying condition comprises a past-due condition for a payment on the account that persists for a predetermined number of days.

13. The computer program product of claim 11, wherein the one or more predetermined ability to pay indicators are evaluated using information selected from the group consisting of income, household assets, financial accounts, and cash on hand.

14. The computer program product of claim 11, wherein the one or more predetermined ability to pay indicators are evaluated using information selected from the group consisting of capacity to pay and disposable income score.

15. The computer program product of claim 14, wherein the selected information is provided by a creditor for the account.

16. The computer program product of claim 11, wherein the one or more ability to pay indicators are evaluated using information selected from the group consisting of credit limits on bankcards, credit balances on bankcards, loan balances and debtor discretionary spending.

17. The computer program product of claim 16, wherein the selected information is provided by one or more credit bureaus.

18. The computer program product of claim 11, wherein the one or more predetermined willingness to pay indicators are evaluated using information about one or more of a past action taken by the debtor or a past account status.

19. The computer program product of claim 11, wherein the API is computed using a respective model implemented as a committee model, the committee model combining a plurality of binary variables each based on a respective one of the one or more predetermined ability to pay indicators and evaluated as a function of a respective predetermined cut-off value.

20. The computer program product of claim 11, wherein the WPI is computed using a respective model implemented as a committee model, the committee model combining a plurality of binary variables each based on a respective one of the one or more predetermined ability to pay indicators and evaluated as a function of a respective predetermined cut-off value.
